(19) United States
(12) Patent Application Publication
(10) Pub. No.: US 2002/0018139 A1
(43) Pub. Date: Feb. 14, 2002

(54) Device for detecting tilt angle of optical axis and image measuring apparatus equipped therewith

(76) Inventor: Hisayuki Yamagata, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/880,134

(22) Filed: Jun. 14, 2001

(30) Foreign Application Priority Data
Jun. 16, 2000 (JP) P2000-180683

(51) Int. Cl. H04N 5/222

(52) U.S. Cl. 348/333.09

(57) ABSTRACT

Detection of tilt angle of an optical axis of a camera in relation to a vertical line of an image display surface by means of information from image processing, without relying on specific optical apparatus, sensors or the like. A localized focus degree is determined for a plurality of regions within the image display surface and the tilt angle is determined according to an amount of deviation of such focus degree. As values showing such localized focus degree, measurement of image brightness is performed along an extension of such region in an abscissa direction, throughout the whole region in the ordinate direction. Only a difference in brightness between adjacent regions that exceed a designated amount is accumulated, and such accumulated value is divided by a value of an area of a designated region. Such divided value is a focus value in the abscissa direction. Similar procedure is done for the ordinate direction. Then, components of tilt angle of the camera in both axes directions are determined by values of deviation of those values.

### CROSS REFERENCES TO RELATED APPLICATIONS

The present document is based on Japanese Priority Document JP 2000-180683, filed in the Japanese Patent Office on Jun. 16, 2000, the entire contents of thereof are herein incorporated by reference.

### BACKGROUND OF THE INVENTION

1. Field of the Invention

The present invention relates to a device for detecting tilt angle of optical axis, which, for example, detects tilt angle of optical axis of a camera with respect to a vertical line of an image display surface by shooting with a camera the image display surface such as a liquid crystal display device or a plasma display device. It also relates to an image measurement apparatus for conducting measurement, inspection or the like of the above image display surface by using the device for detecting tilt angle of the optical axis.

2. Description of the Related Art

Among various measurement and inspection for devices which display images, for example, of a liquid crystal display element, a plasma display element or the like, there are measurement and inspection to be evaluated by shooting with a camera a desired image displayed on a surface of the device, which are conducted by an image measurement apparatus. One important factor to consider when conducting measurement and inspection with such the image measurement apparatus is that the camera on the image measurement apparatus should correctly face the image display surface, that is, an optical axis of the camera should be vertical to the image display surface, which is the surface of the measured object, because, if there is tilt, the image forming characteristics is remarkably deteriorated.

Accordingly, the adjusting mechanism has been devised to direct the camera to be vertical to the measured object, and one example is disclosed in Japanese Unexamined Patent Application Publication No. 10-176906. To describe the content briefly, an observing light source for observing the measured object and a measuring light source for measurement of tilt of the measured object are provided to be conjugated against the above mentioned measured object, and an observing light and a measuring light projected from the above observing light source and the measuring light source and then reflected from the above mentioned measured object are imaged at a predetermined position by an image forming unit, and according to the observing light and the measuring light imaged at that position, an observed image and tilt are measured by a measurement unit.

There is also another related art that a distance-measuring sensor is installed on an optical axis of the camera and tilt of the camera is determined by measurement of the distance to the measured object.

Incidentally, in the art introduced by the above Publication No. 10-176906, there have been following the problems of (1) to (4), described below:

(1) As the light source, the observing light source (such as a Halogen lamp, a fluorescent lamp, etc.) and the measuring light source (such as a laser diode, etc.) are required, and moreover, a diachronic mirror is practically required to pass the light from the two light sources through the same optical path, so that the number of the portions required increases and the apparatus becomes complicated, leading to a higher price for the image measurement apparatus;

(2) Position adjustment between two optical systems comprising observation optics and measuring optics, namely, alignment of optical axis is required, which originates troublesome work and increases cost;

(3) An image formed by observing light and a measuring spot by measuring light are formed on the same plane, and the two lights influence each other, affecting measurement accuracy. It is, though, not impossible to guarantee accuracy by image processing. In such case, however, special image processing is required, leading to use of a particular software program, which also causes the image measurement apparatus to be more expensive; and

(4) A collimator is detected by the amount of displacement from a reference point, for example, displacement from a cross-lined measuring mark. Measurement is executable on the premise that there exists beforehand data (reference point) related to such inclination or tilt. If there is no such data, there occurs a fundamental problem that measurement of the tilt of the camera cannot be performed.

Another related art to determine tilt of the camera by measurement of the distance to the measured object using the distance-measuring sensor installed on optical axis of the camera has the following problems from (5) to (7), described below:

(5) The distance between the measured object and the camera is available, but the direction of the optical axis is not available;

(6) Without data on distance (reference point) when there is no tilt beforehand, a tilting condition of the camera is not available; and

(7) On the occasion in which a mirror reflection light and an irregular reflection light are simultaneously generated because mirror reflection object (LCD panel, etc.) such as transparent film, glass or the like is provided on the surface of the measured object, accurate measurement can not be performed, thereby originating great fluctuation on output, caused by the tilt of the detected object.

### SUMMARY OF THE INVENTION

The present invention has been made to solve the above-described problems, and its an object thereof to provide a device for detecting tilt angle of optical axis capable of detecting tilt of optical axis of a camera with respect to a vertical line of an image display surface only through image information processing without installing a particular optical system for detecting tilt angle or a sensor, as well as to provide an image measurement apparatus using the device for detecting tilt angle of the optical axis.

The device for detecting tilt angle of optical axis according to a first preferred embodiment of the present invention detects a localized focus degree in plural regions within the image display surface, and detects and determines tilt angle of optical axis by a deviation of focus degree such that the larger the deviation, the larger the tilt angle.

Therefore, according to such first preferred embodiment of the present invention, the device for detecting tilt angle of optical axis detects the focus degree in plural regions within the image display surface only by image processing, thereby capable of detecting tilt angle without the need of a particular optical system or sensor for detecting the tilt angle.

In other words, if the camera and the image display surface face each other correctly, there ought to be almost no difference in the localized focus degree in plural regions within the image display surface. If they do not face correctly each other, namely, if the optical axis of the camera is tilted with respect to the vertical line of the image display surface, there ought to exist difference in the focus degree in plural regions. The larger the tilt angle, the larger the difference in the focus degree. For instance, there may occur the case that a certain region has a so-called front focusing but another certain region has a so-called rear focusing. Accordingly, the tilt angle can be determined correctly by the deviation (difference) of the localized focus degree, and the present invention of this aspect utilizes this principle effectively.

A device or apparatus for detecting tilt angle of optical axis according to another preferred embodiment of the present invention is characterized by calculating, as a value of a localized focus degree in a region within an image display surface, a brightness value of an image along one direction starting from one end to another end of the above mentioned region. This practice to find the brightness values is conducted in order to cover the entire region in a direction perpendicular to the pertinent one direction. The brightness values exceeding a designated value with regard to differences between the pertinent one direction and an adjacent portion thereto are added up all over the aforesaid regions to then determining the focus value in the aforesaid one direction by dividing the above added value by the area of the pertinent designated region.

Therefore, the device for detecting a tilt angle of optical axis according to such preferred embodiment of the present invention can numerically determine a level of adjustment of a localized focus in a region, namely, a focus degree, through quantization, computation or the like of brightness of the image obtained from the image display surface through the camera. The deviation of the focus degree, namely, the amount of tilt angle of the optical axis of the camera can be expressed numerically as a numerical focus value obtained by computation or the like, and precise processing of modifying tilt angle or the like can be easily executed. The reason for not employing the value of difference in brightness that is lower than a designated value as a target for accumulation is that the purpose her is to detect a crest of peak of brightness.

A device for detecting tilt angle of optical axis according to still another preferred embodiment of the present invention is characterized by making the setting of designated regions for finding focus by placing them in order in a plurality in one direction (for example, X direction: pan direction or Y direction: tilt direction) and detect the above tilt angle in the aforesaid one direction.

Therefore, according to such preferred embodiment of the present invention, the region for detecting the focus is distributed by the device for detecting the tilt angle of the optical axis along one direction, so that the tilt angle in the pertinent direction may be detected.

The device for detecting tilt angle of optical axis according to a further preferred embodiment of the present invention is characterized by disposing a plurality of regions to detect focus value along one direction (for example, X direction: pan direction) and along a direction perpendicular (for example, Y direction: tilt direction) to the aforesaid one direction.

Therefore, according to such preferred embodiment of the present invention, the device for detecting tilt angle of optical axis disposes a plurality of regions to detect localized focus value along one direction (for example, X direction: pan direction) and along a direction perpendicular (for example, Y direction: tilt direction) to the aforesaid one direction, so that the elements in the two directions where the aforesaid tilt angles intersect each other may be detected.

The device for detecting tilt angle of optical axis according to a still further preferred embodiment of the present invention is characterized by making a setting of a designated region where the image is obtained by the aforesaid camera on the image display surface within the central part of the pertinent image display surface.

Therefore, according to such preferred embodiment of the present invention, the device for detecting tilt angle of optical axis can detect tilt by processing the image by bright light passing through the central portion of an image forming lens system of the camera, so that detection accuracy can be increased.

An image measurement apparatus according to a preferred embodiment of the present invention comprises a camera, a control mechanism for controlling tilt angle of optical axis of the pertinent camera with respect to the aforesaid image display surface, and a device for detecting tilt angle of optical axis according to a further preferred embodiment of the present invention, and is characterized in that by deviation of the focus value detected by the pertinent device for detecting tilt angle of optical axis, the above control mechanism is made to control tilt angle of the above camera so that the deviation of the above focus degree becomes small.

Therefore, the image measurement apparatus according to such preferred embodiment of the present invention performs negative feedback of an output of the device for detecting tilt angle of optical axis to the control mechanism for controlling tilt angle of optical axis of the camera so that deviation of focus value in a plurality of regions of the above device for detecting tilt angle of optical axis becomes small, thereby capable of automatically controlling the tilt angle of the optical axis of the camera to become zero or approximately zero.

Basically, the device for detecting tilt angle of optical axis according to the preferred embodiment of the present invention captures the image of the image display surface and evaluates tilt of optical axis of the camera with respect to the vertical line of the image display surface by the deviation of the focus degree in the plural regions within the image display surface, but it is preferable that the plural regions can be established within a comparatively narrow region of the central part of the image display surface. Because detection of the tilt can be conducted by processing the image by bright light passing through the central part of the image forming lens system of the camera, detecting accuracy may be enhanced. Even when setting up a plurality of designated regions, it is preferable that all those designated regions may be set within a comparatively narrow region within the central portion of the image display surface.

It is preferable that the focus degree is expressed by the focus value in one direction obtained numerically. This is because deviation between the plural focus degrees can be numerically obtained by computation, and easy computation may be conducted, and the tilt may be grasped objectively by a numeric value. The focus value in one direction is a value calculated in such a manner that measurement of the brightness value of the image along the above one direction ranging from one end to the other end of a certain region is conducted all over the region in a direction perpendicular to the pertinent one direction, and accumulation of values that exceed a designated value with regard to the differences in brightness in the portion adjacent to the pertinent one direction is conducted in the whole part of the above region, and then calculation of the focus value is conducted by dividing the above summed value by the area of the pertinent designated region.

The tilt angle θ of the optical axis of the camera includes an element θx referring to one direction, for example, a lateral direction (X direction: pan direction) and an element θy referring to a vertical direction (Y direction: tilt direction. Unless any of both elements can be detected, adjustment of the tilt cannot be achieved. If the plural areas to detect the focus degrees are disposed in one direction, an element of the tilt angle in that one direction may be detected. Accordingly, in order to detect the tilt of the optical axis of the camera in both directions of the lateral direction (X direction: pan direction) and the vertical direction (Y direction: tilt direction), the plural regions are disposed along the two directions intersecting each other at right angles, and detection of the tilt of the optical axis of the camera in those directions by the deviation between the focus degrees (focus values) may be conducted at the same time or different time with regard to two directions intersecting each other at right angles. Practically, as the orientation of the image display surface with respect to the visibility of the camera is important, it is desirable to conduct detection of the orientation (circumscribing detection), for example, before measurement of the tilt of the optical axis. As a matter of course, it is needless to say that the orientation should be adjusted correctly in case of disadjudtment.

In the case of measurement of the focus, it is subject to influence of moiré when providing just focus. Therefore, it might be better to use a light diffusing plate having microscopic unevenness.

The image measurement apparatus using the device for detecting tilt angle of optical axis according to the present invention may be constituted such that output of the device for detecting tilt angle of optical axis may be negatively feed backed to the optical axis control mechanism of the camera. The typical example of a measuring object for the image measurement apparatus according to the present invention is a liquid crystal display panel (LCD panel). It does not matter whether the liquid crystal display panel is of backlight type or of reflected light type. In addition, the overall flat displays such as other plasma displays, electro luminescence (EL), flat type cathode-ray tube displays can be used as measurement objects for the image measurement apparatus of the present invention.

A device for detecting tilt angle of optical axis according to a preferred embodiment of the present invention is capable of detecting a tilt angle of an optical axis of a camera by detecting a focus degree in plural regions of an image display surface only through image processing, and does not require a particular optical system or a sensor to detect the tilt angle. Specifically, as there is no need of two optical systems for observation and adjustment of optical axis, not only the number of the portions to be used is small, but also the number of assembling work is reduced because adjustment of the two optical systems are not required. Consequently, it is possible to achieve reduction in manufacturing cost of the device for detecting tilt angle of optical axis. As it is not the case that image processing is made to form a small spot image by measurement of light and an image by observing the light on the same surface, the image observation may be performed without having influence from the small spot, thereby enabling detection of the tilt without decrease in accuracy. In addition, data (a reference point) related to a case in which there is beforehand no tilt of the optical axis of the camera is not required, the direction for adjustment may be recognized by first tilting and panning the camera in to constant amoount and then, by detecting increase or decrease of the deviation on focus value.

The device for detecting tilt angle of optical axis according to the preferred embodiment of the present invention can numerically find adjustability of localized focus in the region, namely, focus degree by processing quantization, computation of brightness of image obtained from the image display surface through the camera. The deviation of focus degree, namely, the tilt angle of optical axis of the camera may be expressed numerically as a numerical focus value found by computation, and precise processing of modifying tilt angle or the like may easily be executed.

According to the device for detecting tilt angle of optical axis according to another preferred embodiment of the present invention, the region to find focus value is disposed along one direction, so that tilt angle in the pertinent direction can be detected.

According to the device for detecting tilt angle of optical axis according to another preferred embodiment of the present invention, a plurality of regions for detecting localized focus values are disposed along one direction (for example, X direction: pan direction), and along a direction perpendicular to the aforesaid one direction (for example, Y direction: tilt direction), so that elements of the aforesaid tilt angle in two directions intersecting each other at right angles may be detected.

The device for detecting tilt angle of optical axis according to still another preferred embodiment of the present invention can process an image through bright light passing the central portion of an image forming lens system of the camera and detect tilt, so that detecting accuracy is enhanced.

An image measurement apparatus according to a preferred embodiment the present invention performs negative feedback of an output of the device for detecting tilt angle of optical axis to a control mechanism for controlling tilt angle of optical axis of the camera so that deviation of focus value in plural regions which is an output of the above device for detecting tilt angle of optical axis can become small, thereby capable of automatically control the tilt angle of the optical axis of the camera to become zero or approximately zero.

### BRIEF DESCRIPTION OF THE DRAWINGS

The foregoing and other objects, features and advantages of the present invention will be apparent to those skilled in the art from the following description of the preferred exemplary preferred embodiments of the present invention taken in conjunction with the accompanying drawings, in which:

FIG. 1 is a schematic diagram showing an image measurement apparatus according to a preferred embodiment of the present invention;

FIG. 2 is a perspective view showing a LCD panel on an xy plane and a camera having its optical axis tilted by a tilt angle θ with respect to the LCD panel according to a preferred embodiment of the present invention;

FIG. 3 is a graph showing brightness values plotted from x=x0 to x=x1 on the lines of y=y0 of the focus measurement region W1. An abscissa axis shows a position in X direction and an ordinate axis shows value of brightness, according to a preferred embodiment of the present invention;

FIG. 4 is a diagram illustrating a case of measurement of value of focus in the x direction: pan direction according to a preferred embodiment of the present invention;

FIG. 5 is a graph plotting value of focus Fxn in x the direction, according to a preferred embodiment of the present invention;

FIG. 6 is a diagram illustrating a case of measurement of value of focus in the y direction: tilt direction, according to a preferred embodiment of the present invention;

FIG. 7 is a graph plotting value of focus Fyn in the y direction, according to a preferred embodiment of the present invention;

FIGS. 8A to 8D are curved graphs respectively showing each example of distribution charts of focus value Fxn in one direction (for example, x direction), according to a preferred embodiment of the present invention;

FIG. 9 is a block diagram showing a configuration of an image processing device embedded in an image measurement apparatus, according to a preferred embodiment of the present invention; and

FIG. 10 is a flowchart of a program for adjusting tilt of an optical axis of a camera to the vertical direction, according to a preferred embodiment of the present invention.

### DESCRIPTION OF THE PREFERRED EMBODIMENTS

Hereinafter, preferred embodiments of the present invention are described in detail with reference to the drawings.

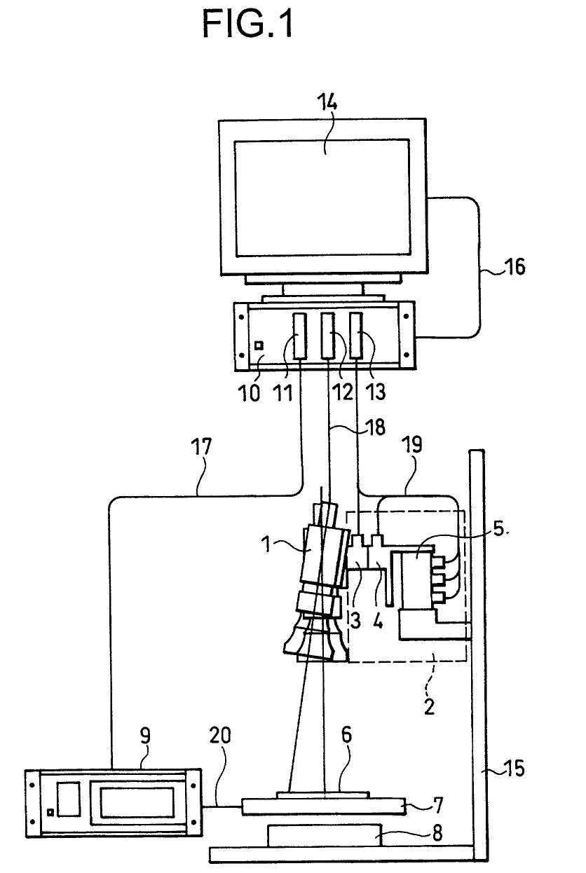

FIG. 1 is a schematic diagram showing one embodiment of an image measurement apparatus according to the present invention. 1 is a camera using, for example, a CCD (Charge Coupled Device) solid image pickup element as its image pickup means, which shoots from upper position an LCD panel 6, a measured object, positioned below the camera 2 is a camera positioning mechanism, which is fixed to a rack 15 while holding the camera 1 to be positioned.

The above camera registration mechanism 2 comprises a tilt control mechanism 3 for controlling tilt of an optical axis of the camera 1 in a vertical direction (Y direction: tilt direction), a pan control mechanism 4 for controlling a tilt of an optical axis of the camera 1 in likewise a lateral direction (X direction: pan direction), and an XYZ control mechanism 5 for controlling a position of the camera 1 likewise in the X direction, the Y direction and the Z direction (optical axis direction), with respect to the LCD panel 6 of the above measured object. The tilt control mechanism 3 and the pan control mechanism 4 have commonly the same center of rotation and are configured such that the center position is not deviated. The above tilt control mechanism 3, the pan control mechanism 4, and the XYZ control mechanism 5 are connected to a motor-controlled board 13 within a personal computer 10 by a motor-controlled cable 19, and thus controlled.

The LCD panel 6 of the measured object is fixed to a connecting jig 7, receives the supply of a driving voltage and a signal from an LCD driving unit 9 through an LCD driving signal cable 20, and displays a pattern for measurement on the panel. The LCD driving unit 9 is connected to an RS-232C interface board 11 within the above personal computer 10 by an RS-232C interface cable 17, and thus controlled.

With regard to the above connecting jig 7, the portion corresponding to the LCD panel 6 is left off, so that a back light 8 underneath the panel may be able to irradiate the LCD panel 6. Moreover, the above rack 15, though not shown, is overall covered with a lightproof board, thereby protecting from receiving an influence of outer light.

An image data of the LCD panel 6 shot by the camera 1 is inputted to an image processing board 12 within the personal computer 10 through a camera cable 18, and a variety of image processing is conducted according to the contents of inspection and measurement. A through image of the camera 1, an image to be processed, and a result of processing are displayed on an image monitor 14 from the personal computer 10 through a monitor cable 16.

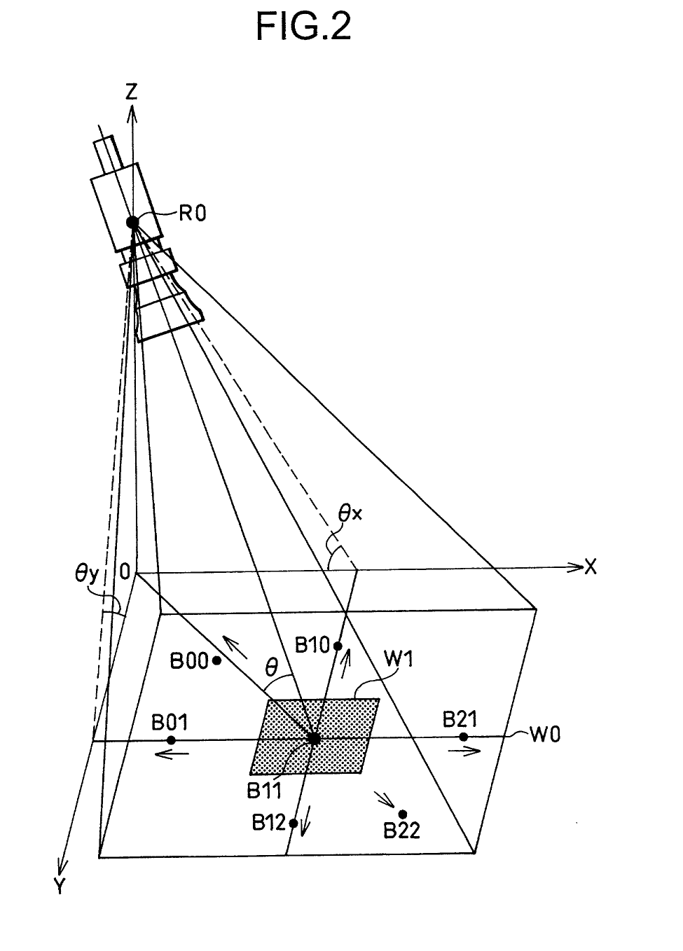

FIG. 2 is a perspective view showing the LCD panel on the xy plane and the camera having its optical axis tilted by θ with respect to the vertical line of the surface of the LCD panel. θx is a tilt component of the tilt θ to the x-axis direction or abscissa, and θy is a tilt component of the tilt θ to the y-axis direction or ordinate. R0 shows a center of rotation for the tilt control mechanism 3 and the pan control mechanism 4.

When an all white signal is inputted to the LCD panel 6, a whole portion of the effective display screen of the panel 6 is turned into a state of white radiance. In such state, the camera 1 is zoomed so that the radiated screen may come within the angle of view of the camera 1 and the focus is adjusted. Also in this state the camera captures the image and conducts a circumscribing detection (detection of relationship between positions of respective side rims of the panel 6 and the camera 1) of the whole radiated screen, and evaluates an image region W0. Within the image region W0, especially within the central part thereof, a considerably narrow region, that is, a focus value measurement region W1 is established. The reason why the focus value measurement region W1 is established like this in a narrow region of the central part of the image region W0 is that light passing through the central part of the image forming lens system of the camera 1 is bright and capable of enhancing the measurement accuracy.

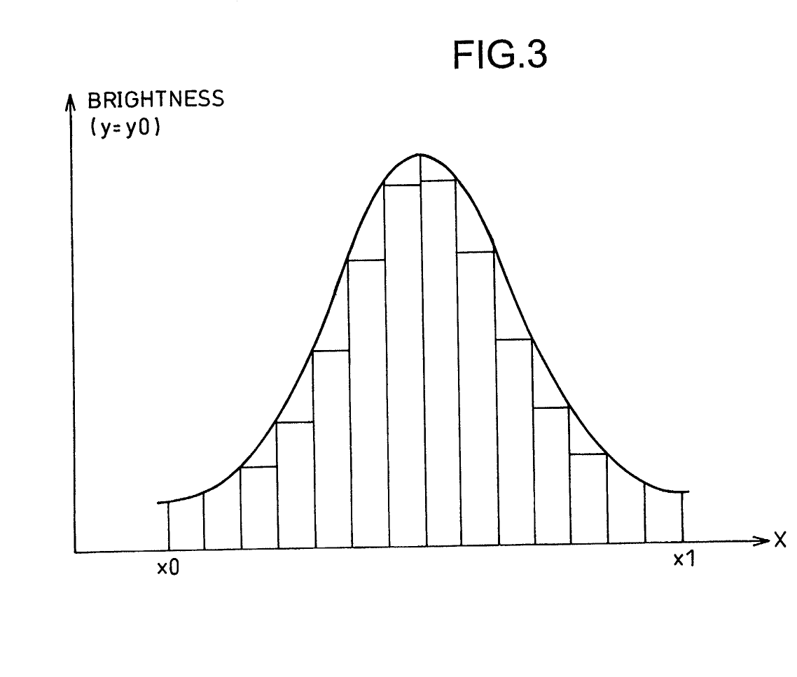

Supposing the coordinates of the upper left corner of the above focus value measurement region W1 is (x0, y0), and that of the lower right corner thereof is (x1, y1), there is described hereafter a focus value in such region W1 by referring to FIG. 3.

FIG. 3 shows a value of brightness value on a line y=y0 of the focus measurement region W1 by plotting from x=x0 to x=x1. A lateral axis shows positions in the x direction and a vertical axis shows the values for brightness.

Differences in brightness between an adjacent address to a frame memory which has captured an image shot by the camera 1 are obtained from x=x0 to x=x1, and only the differences in brightness which exceed a predetermined designated value are computed. The reason for computing only the differences in brightness exceeding the designated value are is that the purpose here is to detect a peak of the brightness. Such practice is conducted within a range from y=y0 to y=y1. The value evaluated by summation of differences in brightness obtained like this divided by an area of the focus measurement region W1 of (x1−x0)*(y1−y0) is a focus value in the region W1. The focus value shows an adjustability of focus in the region (focusing region) where focus of the camera has been achieved. It might be said that the larger this value, the better focus adjustment.

The principle of the device for detecting tilt angle of optical axis embedded in the image measurement apparatus according to a preferred embodiment of the present invention is that there is a plurality of the focus measurement regions established, the tilts are detected by deviation of each focus value, the optical axis of the camera is adjusted to the direction in which the deviations are decreased, and the tilt θ is adjusted so that the deviation becomes the smallest. Because the larger the angle of the optical axis of the camera with respect to the vertical line of the display surface, the larger the difference in focus degree between the plural focus measurement regions, and the smaller the angle the smaller the difference in focus degree, the tilt angle can be recognized correctly by those deviations. Therefore, there is concretely described hereunder a method of how to practically setting the plural focus measurement regions and obtaining the tilt θ, more specifically, the tilt components θx, θy.

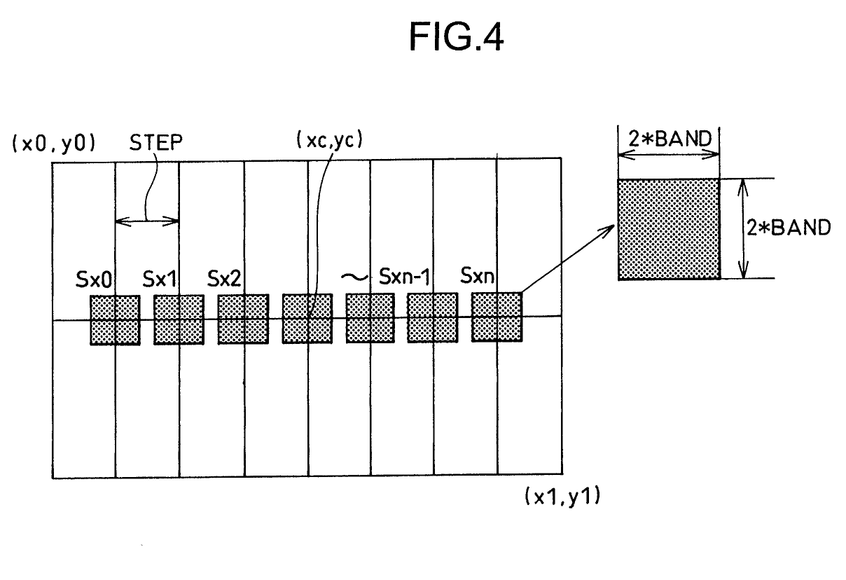

FIG. 4 is a screen diagram illustrating the case of measurement of focus value in the x direction: pan direction. With regard to the region W1 (referring to FIG. 2), supposing the coordinate of the upper left corner is (x0, y0), that of the lower right corner is (x1, y1) and that of the center is (xc, yc), within this region W1, n pieces of focus value measurement regions Sxn are established. Specifically, the region W1 is divided into (n+1) pieces of portrait rectangles having a same width, and points of intersection of each of the dividing lines (dividing lines between rectangles) and a line of y=yc are supposed to be the centers of each of the focus value measurement regions Sxn. Supposing the sizes of vertical direction and lateral direction of each region are both 2*band, and the interval (region placement pitch) between the centers of adjacent focus value measurement regions is a step, the coordinate (xn0, yn0) of the upper left corner and the coordinate (xn1, yn1) of the lower right corner of each of the focus value measurement regions Sxn are given by the following expressions.

step=(x1−x1)/(n+1)

xn0=x0+step*(n+1)−band

xn1=x1+step*(n+1)+band

yn0=yc−band

yn1=yc+band

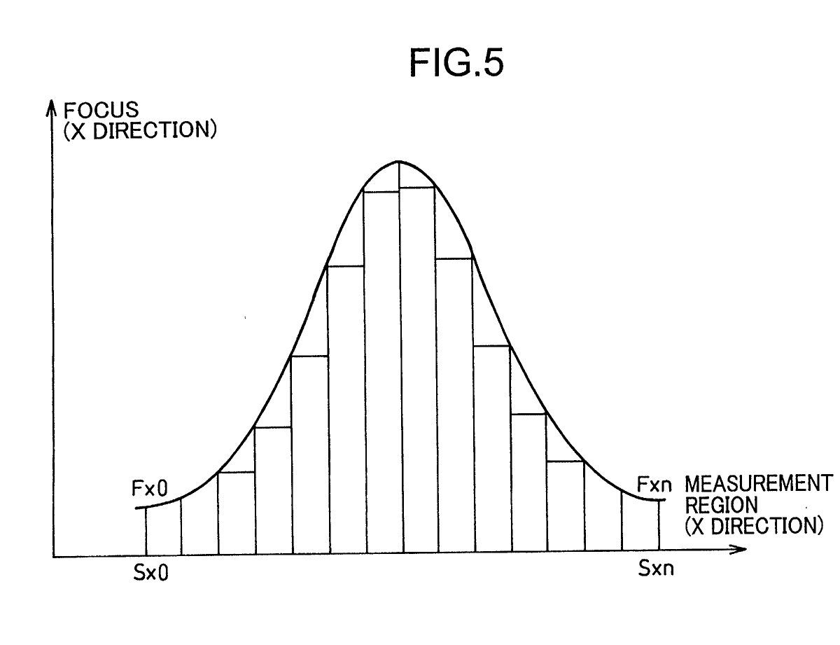

On the line y=yc−band in the focus value measurement region Sxn of the frame memory which has captured the image from the camera, the differences in brightness of the adjacent addresses in the x direction are evaluated ranging from x=xn0 to x=xn1. On the occasion that the values of the differences in brightness exceeded the predetermined designated value, those differences in brightness are summed. Similar practice is conducted with regard to each line ranging from y=yc−band to y=yc+band, and the added values of the above differences in brightness of each line are summed up. The value which is found by dividing the sum of the added value obtained like this by the area of the focus value measurement region Sxn, namely, 4 band by 2, is given as the focus value Fxn in the x direction of that focus value measurement region Sxn. FIG. 5 is a graph showing one example of a case of plotting the focus value Fxn in that x direction, and the balance of the focus values in the x direction (pan direction: lateral direction) can be obtained.

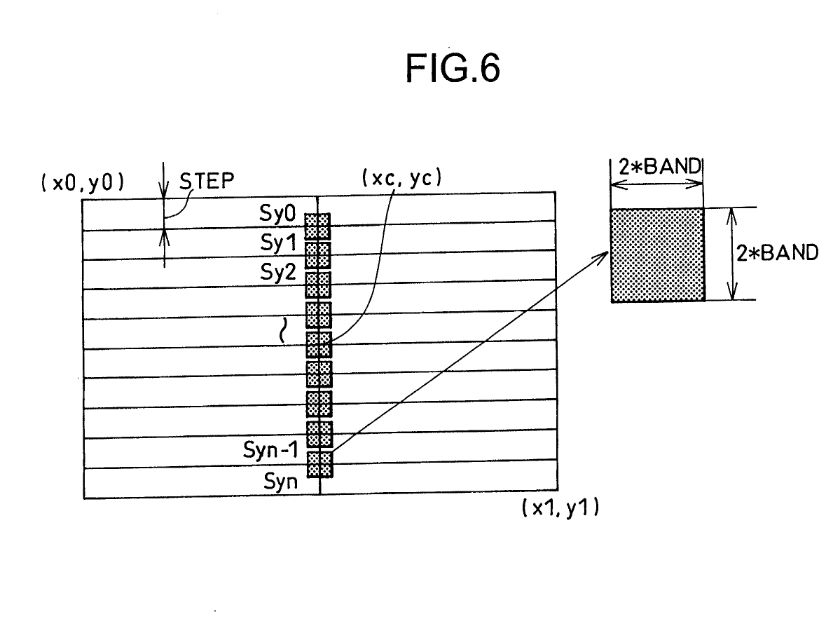

FIG. 6 is a screen diagram illustrating the case of measurement of focus value in the y direction: tilt direction. With regard to the region W1 (referring to FIG. 2), supposing the coordinate of the upper left corner is (x0, y0), that of the lower right corner is (x1, y1), and that of the center is (xc, yc), which is the same case as finding the focus value in the x direction, within this region W1, n pieces of focus value measurement regions Syn are established. Specifically, the region W1 is divided into (n+1) pieces of landscape rectangles having the same width, and points of intersections of each of the dividing lines (dividing lines between rectangles) and the line of x=xc are supposed to be the centers of each of the focus value measurement regions Syn. Suppose the sizes in the vertical direction and lateral direction of each region are both 2*band, and the interval (region placement pitch) between the centers of the adjacent focus value measurement regions is a step, the coordinate (xn0, yn0) of the upper left corner and the coordinate (xn1, yn1) of the lower right corner of each of the focus value measurement regions Syn are given by the following expressions.

step=(y1−y0)/(n+1)

xn0=xc−band

xn1=xc+band

yn0=y0+step*(n+1)−band

yn1=y1+step*(n+1)+band

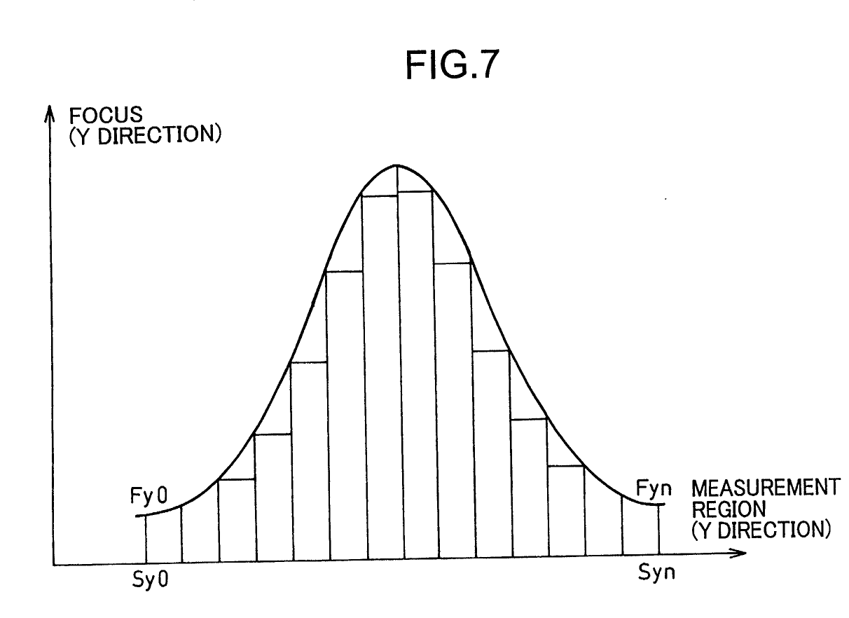

On the vertical line of x=xc−band in the focus value measurement region Syn of the frame memory which has captured the image from the camera, the differences in brightness of the adjacent addresses in the y direction are evaluated ranging from y=yn0 to y=yn1. On the occasion that the values of the differences in brightness are more than the predetermined designated value, those differences in brightness are summed. Similar practice is conducted with regard to each vertical line ranging from x=xc−band to x=xc+band, and the added value of the above differences in brightness of each line are summed up. The value which is found by dividing the sum of the added value obtained like this by the area of the focus value measurement region Syn, namely 4 band by 2, is given as the focus value Fyn in the y direction of that focus value measurement region Syn. FIG. 7 is a curved graph showing one example of the case of plotting the focus value Fyn in that y direction, and the balance of the focus values in the y direction (tilt direction: vertical direction) may be acquired.

By the practice mentioned above, focus values Fxn and Fyn can be obtained respectively in the plural focus value measurement regions Sxn and Syn. However, even if focus values Fxn and Fyn are obtained, such effort is meaningless unless the direction of optical axis of the camera is controlled such that, based on those focus values, the tilt angle θ becomes zero with respect to the vertical line of the surface of the LCD panel 6 which is the inspected object of optical axis of the camera 1. Therefore, hereunder, there is described a method of how to conduct an optical axis control.

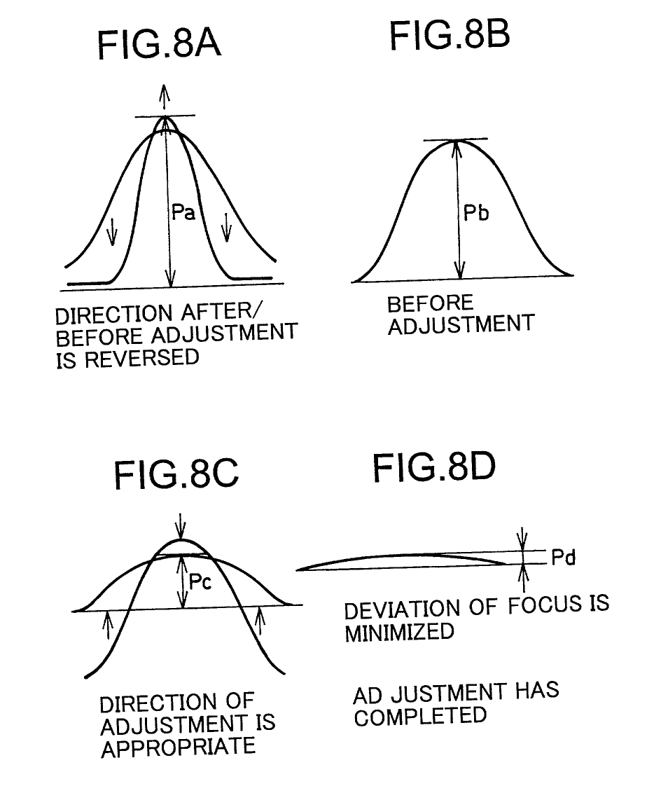

FIGS. 8A to 8D are graphs respectively showing each example of distribution charts of focus value Fxn in one direction (for example, the x direction). The image measurement apparatus of the present invention controls a tilt of optical axis of the camera 1 so that a peak of the curve showing distributions may become small, because, as described above, the larger the tilt is, the larger becomes the deviation of focus value in the plural focus value measurement regions, for example, focus value Fxn in Sxn. In other words, the value of peak P of the graph showing distributions of focus values shown in FIG. 5 or the like becomes large. More specifically, by controlling the direction of optical axis of the camera 1 so as to eliminate the peak, the angle θ with respect to the vertical line of the LCD panel 6 can be made to be small, and finally to be zero. According to the example of FIG. 8A, the peak has become adversely large. This is nothing else but the direction of optical axis adjustment being reverse. More specifically, before adjustment, the peak is in the state as shown in FIG. 8B (the peak is in the state of Pb), but by adjustment, the peak has become the state of Pa of FIG. 8A. This means that adjustment has been made to the direction that the tilt angle becomes large.

Conversely, FIG. 8C shows an example in which the direction of adjustment is correct. In this case, the peak P of the above curve changes from the state of Pb shown in FIG. 8B to the state of Pc shown in FIG. 8C , and the peak is reduced. This is because the deviation of focus value Fxn in the plural focus value measurement regions, for example, Sxn is reduced, and it is nothing else but tilt angle θ, for example, θx been reduced. By proceeding with such adjustments, when the deviation reaches a minimum value as shown in FIG. 8D, namely, the peak P of the curve has reached the minimum value Pd, the adjustment is completed. In other words, the tilt angle θ, for example, θx has become zero or approximately zero.

By referring to FIG. 2, there is described a method of conducting this optical axis adjustment specifically. Supposing the optical axis of the camera 1 before adjusting the optical axis intersects with B11 on the liquid crystal panel, firstly, that optical axis is panned (moved to the x direction) from B11 to the direction of B01 or B21 to check an adjusting direction in the x direction, and then, the image is captured. If the deviation of focus value becomes smaller when moved to the direction of B01, adjusting the direction to the x direction should be to the B01 direction. If the deviation is increased, the moving direction is reversed to the adjusting direction, and therefore, the moving direction should be reversed. When the deviation has reached a minimum, the tilt angle θx of the optical axis with respect to the x direction has become zero or approximately zero.

If such adjustment is conducted not only in the x direction but also in the y direction, the x direction component θx and the y direction component θy of the tilt angle θ may be obtained. Therefore, there is a specifically description also with regard to the y direction by referring to FIG. 2. To check the adjusting direction in the y direction, the optical axis is firstly tilted from the direction of B11 to B10 or B12 to detect the focus value. If the deviation of that focus value becomes smaller, it is the direction that the adjustment should be made. With proceeding to move to that direction, when the deviation has reached a minimum, it can be considered that θy has become zero or approximately zero. On the occasion that the focus value has become adversely larger, that tilt direction is reversed to the adjusting direction, and therefore, moving direction should be reversed and moving in that reversed direction should be continued until the focus value is decreased to a minimum value.

Moreover, component θx in the x direction and component θy in they direction of the tilt angle θ can be adjusted in sequence, or simultaneously (in parallel), because adjusting time may be curtailed. For curtailing the adjusting time as much as possible, the pan control and tilt control are conducted simultaneously, and the position of the optical axis on the LCD panel 6 is moved to the direction from B11 to B00 or B22 by linear interpolation, thereby capable of recognizing the direction for adjustment. Herein, movement by linear interpolation signifies that a velocity of moving in a slanting direction with respect to x-axis and y-axis is established, the velocity of each axis is found by computation, and at that velocity, movement is conducted at the same time to the x direction and the y direction.

As a result, the direction of adjustment is determined, the pan and tilt are conducted to that direction, and the adjustment can be performed so that the focus value of above-below and left-right portiond in the region in which the focus is achieved (focusing region) may reach a minimum. Then, the optical axis linearly moves from B11 to a point in which θx and θy each having a deviation of focus value reaching a minimum becoming zero or approximately zero, thereby capable of adjusting at the shortest time.

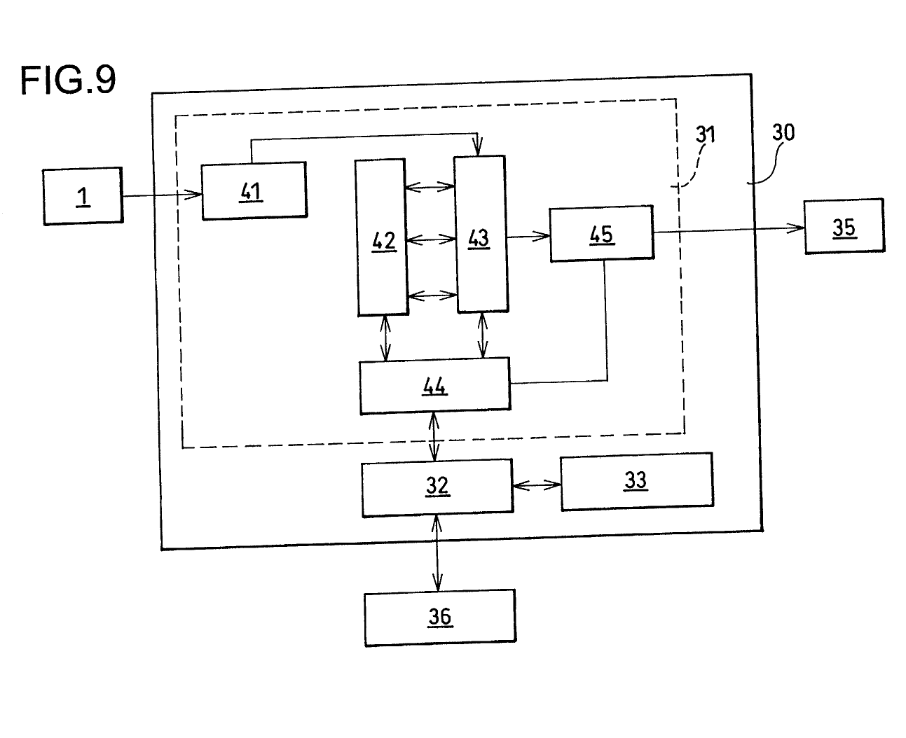

FIG. 9 is a block diagram showing a configuration of an image processing device 30 embedded in an image measurement apparatus. The image processing device 30 includes an image processing board 31, a host CPU (host central processing unit) 32, and a program memory 33. An analog output from the camera 1 is converted to a digital signal by an A/D (Analog/Digital) converter 41 in the image processing board 31, and stored in an image memory 43. The image stored in the image memory 43 is inputted to an image processor 42, and stored in the image memory 43 after image processing and measurement. The image memory 43 has a plurality of frame memories, and ordinarily the original image and the processed image are stored in different frame memories.

An image processing signal stored in the image memory 43 is computed in an image CPU (image central processing unit) 44, and outputted to an image monitor through a D/A (Digital/Analog) converter 45 to display an image. The aforesaid host CPU 32 conveys image data to the image CPU 44 and to a motor controller 36 and at the same time performs a series of jobs including adjustment of optical axis required for inspection and measurement such as receiving processing data or the like. The program memory 33 is the unit that stores programs to be executed by the host CPU 32.

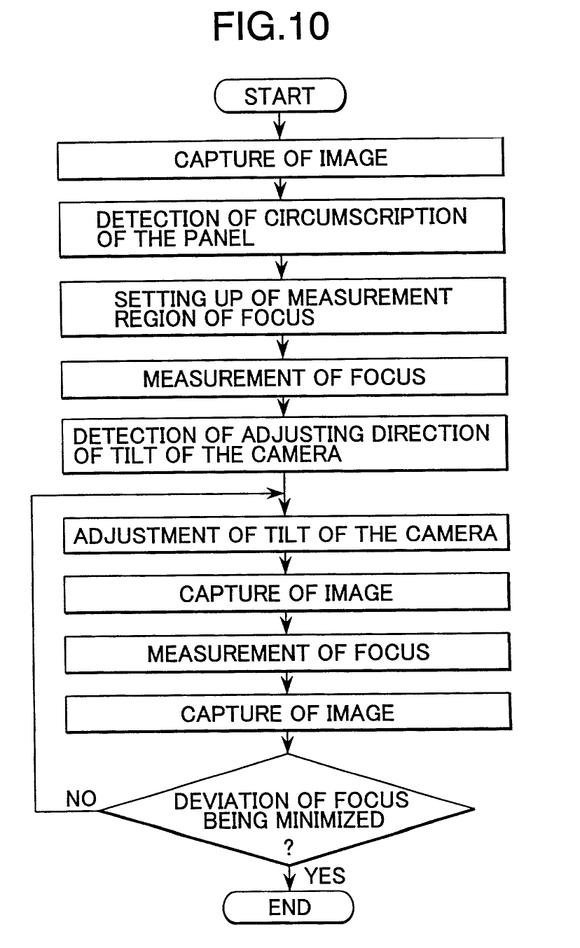

FIG. 10 is a flowchart of a program for adjusting a tilt of an optical axis of a camera to be vertical; such program is one among the programs to be executed by the aforesaid CPU 32. The flowchart is described in the following order: starting, image capturing, first detection of circumscription of the panel, adjustment of such circumscription, then setting a region for measurement of focus value, followed by measurement of focus value, detection of adjusting direction of a tilt of the camera, and adjustment of the tilt of the camera. Then, capturing of the image again, measurement of focus value and capture of the image again. Thereafter, determination of whether or not deviation of focus value is minimum. If the result of determination is negative, returning to adjustment of the tilt of the camera, but if the result of determination is affirmative, the flowchart comes to an end.

Finally, the configurations and structures of respective units and portions described specifically with respect to the preferred embodiments of the present invention are only examples of realization of the present invention, so the embodiments thereof should not be construed as to limiting the technical scope of the present invention.

What is claimed is:

1. A method of detecting tilt angle of an optical axis of a camera shooting an image display surface, in relation to a vertical line of said image display surface, said means comprising:
a means for detecting a localized focus degree in a plurality of regions within said image display surface; and
a means for determining a tilt angle according to a value of deviation of said localized focus degree of said plurality of regions.

2. The method of detecting tilt angle of an optical axis according to claim 1, wherein said means for detecting said localized focus degree further comprises:
a means for determining brightness value of an image from one end to another end of said region along one direction, wherein said means for determining brightness value covers a whole region in a direction perpendicular to said one direction;
a means for accumulating a difference in brightness value adjacent portions of said region in said one direction only for an amount exceeding a fixed value, wherein said means for accumulating performs accumulation throughout said region; and
a means for dividing said accumulated difference in brightness value by a value of area of said region.

3. The method of detecting tilt angle of an optical axis according to claim 2, wherein
said plural regions to detect focus value in said one direction are disposed along one direction; and
said tilt angle in said one direction is detected by a value of deviation of focus values in said plural3 regions.

4. The method of detecting tilt angle of optical axis according to claim 2, wherein
said plural regions to detect focus value in said one direction are disposed along one line;
said plural regions to detect focus value in an perpendicular direction to said one direction are disposed along said perpendicular direction;
said tilt angle in said one direction is determined by a deviation in focus value in said plural regions disposed along said one direction;
said tilt angle in said perpendicular direction to said one direction is detected by deviation of focus value in said plural regions disposed along said perpendicular direction to said one direction; and
said detection of tilt angle in said one direction and in said perpendicular direction is performed separately or simultaneously.

5. The method of detecting tilt angle of optical axis according to claim 3, wherein
said plural regions to detect focus value in said one direction are disposed along one line;
said plural regions to detect focus value in an perpendicular direction to said one direction are disposed along said perpendicular direction;
said tilt angle in said one direction is determined by a deviation in focus value in said plural regions disposed along said one direction;
said tilt angle in said perpendicular direction to said one direction is detected by deviation of focus value in said plural regions disposed along said perpendicular direction to said one direction; and
said detection of tilt angle in said one direction and in said perpendicular direction is performed separately or simultaneously.

6. The method of detecting tilt angle of optical axis according to claim 1, wherein a region of detection of localized focus degree within said image display surface is set to a central portion of said image display surface.

7. The method of detecting tilt angle of optical axis according to claim 2, wherein a region of detection of localized focus degree within said image display surface is set to a central portion of said image display surface.

8. The method of detecting tilt angle of optical axis according to claim 3, wherein a region of detect of localized focus degree within said image display surface is set to a central portion of said image display surface.

9. The method of detecting tilt angle of optical axis according to claim 4, wherein a region of detection of localized focus degree within said image display surface is set to a central portion of said image display surface.

10. An apparatus for detecting tilt angle of an optical axis of a camera shooting an image display surface, in relation to a vertical line of said image display surface, comprising:
a detecting means for detecting a focus degree in plural regions within said image display surface; and
a detecting means for detecting a tilt angle of said optical axis by determining a deviation of said focus degree in said plural regions.

11. An image measurement apparatus comprising:
a camera shooting an image display surface for performing measurement of said image display surface;
a control mechanism for controlling a tilt angle of said camera, in relation to said image display surface; and
a detecting means for detecting tilt angle of an optical axis; wherein
said control mechanism receives a value of deviation of focus value detected by said device for detecting tilt angle of optical axis as an input, and controls tilt angle of said camera.

12. The image measurement apparatus according to claim 10, wherein said detecting means further comprises:
a first disposing means for disposing plural regions of detection of focus value in one direction of said image display surface along said one direction;
a second disposing means for disposing plural regions of detection of focus value in a perpendicular direction to said one direction along said perpendicular direction;
a detecting means for detecting said tilt angle in said one direction using values of deviation of focus value in said plural regions disposed along said one direction; and
a detecting means for detecting said tilt angle in said perpendicular direction to said one direction using values of deviation of focus value in said plural regions disposed along said perpendicular direction to said one direction; wherein
said detecting of tilt angles for different directions performed in sequence or in parallel;

13. A method for detecting tilt angle of an optical axis of a camera shooting an image display surface, in relation to a vertical line of said image display surface, comprising the following steps of:
detecting a focus degree in plural regions within said image display surface; and
detecting tilt angle of said optical axis by determining a deviation of said focus degree in said plural regions.

14. A method for image measurement comprising the following steps of:
shooting with a camera an image display surface;
detecting a tilt angle of an optical axis comprising the following steps of:
detecting a focus degree in plural regions within said image display surface; and
detecting tilt angle of said optical axis by determining a deviation of said focus degree in said plural regions; and
controlling tilt angle of said camera, in relation to said image display surface.
